(19) United States
(12) Patent Application Publication
(10) Pub. No.: US 2013/0177378 A1
(43) Pub. Date: Jul. 11, 2013

(54) METHOD AND SYSTEM FOR THE AUTOMATIC LOADING OF AIR TRANSPORT UNITS

(71) Applicants: Juha Tuominen, Vantaa (FI); Harri Ruoslahti, Vantaa (FI); Arto Juosila, Vantaa (FI)

(72) Inventors: Juha Tuominen, Vantaa (FI); Harri Ruoslahti, Vantaa (FI); Arto Juosila, Vantaa (FI)

(73) Assignee: AHKERA SMART TECH OY, Vantaa (FI)

(21) Appl. No.: 13/816,428

(22) PCT Filed: Aug. 19, 2010
(86) PCT No.: PCT/FI10/50658

§ 371 Date: Mar. 27, 2013

(51) Int. Cl. B65G 65/00

(52) U.S. Cl. CPC B65G 65/00
USPC 414/783; 414/816; 414/754

(57) ABSTRACT

A method and a system for the automatic loading of air-transport units. In the method, the piece goods and the air-transport unit, on at least one side of which is an openable loading opening, are transported to the packing location, when the piece goods are packed automatically through the loading opening into the air-transport unit. The air-transport unit is tilted in connection with the packing, in such a way that the side with the loading opening is raised relative to the side opposite to the loading opening, so that the air-transport unit is loaded in at least two different attitudes.

### TECHNICAL FIELD

The present invention relates to piece-goods automation. In particular, the invention relates to the automatic packing of containers and baggage carts used in air transport. More specifically, the invention relates to a loading method and system according to Claims 1 and 10.

### BACKGROUND ART

It is important for airline business to maximize the time that aircraft are in the air and correspondingly minimize the time that aircraft stand at airports. Besides unavoidable servicing, a great deal of flight capacity is lost in the so-called turnaround of the aircraft, in which the aircraft is unloaded and loaded between landing and take-off. It has been observed that one bottleneck in the turnaround of an aircraft particularly concerns the handling of piece goods, such as bags and packets, to be loaded into the hold. The increase in air traffic has made the elimination of this bottleneck more urgent than ever. This is because the airlines' international reservation system prioritizes short stopover times. Short stopover times of even half an hour can act as an airline's competitive advantage in getting passengers to choose a route with a stopover time offered by the airline. On the other hand, a short stopover time puts considerable pressure on the baggage handling system. A fast airport system and a reliable and rapid packing process can permit shorter stopover times.

The drop in the level of service relating to baggage handling, experienced by passengers especially in recent years, is a nearly direct result of increased air traffic, of the increased handling and security check time required by the baggage moving in it, which additional investments in conveyor and automation technology made in airport infrastructure have been unable to correspondingly shorten, and the increase in the costs relating to a labour-intensive operating culture.

As is known, the loading of piece goods to be transported by air has been quite labour intensive. In a typical loading process, the passengers' baggage is transferred by conveyors from check-in to the technical accommodation. In a packing station located in the technical accommodation, the bags and other piece goods are packed manually into transport units, such as air containers, or baggage carts. The air container is the preferred alternative, because it is lifted when loaded directly into the hold of the aircraft without laborious intermediate stages. It is also very easy to secure air containers reliably. Baggage carts, on the other hand, are towed next to the aircraft, when the bags are transferred and packed into the hold mostly manually.

Automated air-container packing systems, in which the loading of piece goods into a transport unit has been automated using robots, have been developed in order to reduce labour intensiveness. One automated air-container packing system is disclosed in publication EP 1 980 490 A2, in which containers are sent to the loading station, in such a way that the containers' loading openings are next to each other for loading. In the system according to the publication, the containers are brought to the loading station on a roller track and the bags are packed into the containers using a transverse linear conveyor, which also has a lateral-transfer property, in order to move the bags in the direction of travel of the containers. The linear conveyor acting as a feed conveyor can also move vertically relative to the container, in order to maximize the degree of filling.

However, a single robot cell at Amsterdam Schiphol airport is the only known system in practical operation. In the robot cell, developed by Grenzebach Machinebau GmbH, the bags are transported to the cell on a conveyor belt, where the geometry of the piece is detected using machine vision. The bag is also weighed at the same time. The information is sent to a robot, which plans the optimal picking operation. After computation, the robot picks the bag and loads it into the air container or other air-transport unit. The robot is programmed to load each air container as fully as possible, in order to maximize transport capacity, due to which the arrangement requires a significant number of sensors and control capacity, in order to determine the container's degree and pattern of filling.

Despite an extensive and known customer need, corresponding robot cells have not, however, spread for use in other airports. From the information available from the publication and other sources, it can be concluded that the implemented solution demands a purpose-designed baggage handling system, as well as the existence of other infrastructure serving automatic baggage packing, for the robot cell in question to be able to pack baggage automatically into an air container.

Significant drawbacks are associated with the prior art. It is obvious that the manual packing of bags and other piece goods is disadvantageous. First of all, a loader's work is extremely stressful, as the manual transfer of bags weighing as much as 40 kg in three shifts is wearing on the employees both physically and mentally. In some countries, an upper limit has been set for the total weight of goods lifted manually during a shift, due to which various tools, for example for lightening the load, and moveable conveyor-belt units have had to be developed. For example, in Denmark, a 4000-kilogramme lifting limit during a work shift, in force in 2010, has had the effect that baggage can only be handled for a few effective working hours. It can therefore be assumed that this work-safety restriction will gradually come into force in many countries. The stressfulness of baggage-handling work appears in the absence percentage of airport loaders (about 12% in Finland in 2009), in which there is a clear difference compared, for example, with average industrial work (about 5-7% in Finland in 2009).

Packing bags manually is not only unreliable, but also extremely expensive. For example, solely the packing costs of the personnel forming packing at Helsinki-Vantaa airport are several million euros annually. In addition to absences, the reliability of packing can also be reduced by potential and actual differences of opinion between labour-market parties. Besides the costs and low reliability as well as the uneven daily traffic distribution of air-traffic timetables of a typical airport, labour capacity planning is quite difficult, because it is a challenge to recruit professional, security-cleared, and reliable temporary labour only to even the peak-period workload. The loading-sector labour agreements also set their own challenge for supervisory employees, not only in terms of recruitment, but also in terms of shift planning, as the aviation baggage-handling work shifts, for example in Finland in 2010, are set as 3, 6, 8, and 12 hours long. Supervisors, who are under continual pressure to produce savings, clearly prefer to underman shifts, rather than dimension capacity to be adequate, which, for its part, causes undesirable stress and other injuries due to hurry and tiredness, arising from unpredictable variations in workload.

Though there has been a long-term need for the automation of the loading of air-transport units, projects like the robot cell operating at Schiphol airport have not become widespread. The reason for this is the complexity of robot systems and the unreliability this causes, as well as the relatively long time, of as much as 15 seconds, taken to automatically load a bag. In order to operate, a robotized packing system like that described demands significant sensoring and control capacity. Several sensors are required even to measure the degree of filling of a single container being packed and to place the next bag in the container when using automation. Loading carried out by robots is also challenging because the sizes of the bags on a conveyor belt are not known precisely, so that stacks are formed to some extent in an irrational order. This causes the stacks of bags to be packed to fall over easily, which leads to an error state, which must be rectified by human labour. Because machine vision provides information only about the external dimensions of a bag, the robot does not receive information, for example, on the external rigidity of a bag. More specifically, the robot is programmed to pick up soft and hard pieces in the same way. For example, in the said robot cell, the picker is a simple plane, on which the pieces are transported freely without lateral or top grabs. In turn, this means that the movements of the robot must be very slow in order to avoid falling, so that at least part of the speed advantage brought by robotization is not achieved. A robot like that described is disclosed in greater detail in US publication 2002/0020607.

Thus, the known automated systems are neither particularly robust nor fast. In addition, due to the complexity of the known automated systems, they are difficult to integrate with the existing infrastructure and the investment costs are high and challenging for those making purchasing decisions.

It is an object of the present invention to resolve at least some of the problems of, on the one hand manual and, on the other automated loading, and to achieve an improved way to arrange the automated loading of air-transport units in a simple and reliable manner cost effectively and causing the least possible alterations to the baggage handling and transport system, so that the totality to be implemented can be dealt with as an equipment purchase, instead of being regarded as an investment in the airport's infrastructure.

### SUMMARY

The packing method and system of the invention are based on a basic idea, according to which loading performed as human labour will not be imitated using robots, but instead the flow of goods will be arranged in such a way that the actual bottleneck, i.e. the packing of the transport units, will be as streamlined as possible. In manual packing, the loaders naturally, as instructed, try to fill the containers as full as possible. However, filling is typically performed in such a way that actual conscious pre-planning of the packing order does not take place, nor is there usually any attempt to pack particularly full, nor is the order of the already packed bags altered to increase the degree of filling. In addition, the robot cells imitating manual packing have been developed to monitor the degree of filling of the air container and to plan the filling of one bag at a time, in such a way that as little empty space as possible remains. Because these solutions have little or no advance information available on baggage, and both the precision of the sensors and image-processing solutions and the computing capacity are limited, the measurement and calculation of the degree of filling and of the remaining empty space are naturally in practice uncertain and challenging.

However, it has been surprisingly observed in measurements performed at an example airport, that, in practice, it is sufficient is the overall degree of filling of containers is only about 70%. When containers are filled manually, or using a known robot arrangement, the first containers are in practice filled only reasonably full, because packing really full is not only an intellectual challenge to people, but also physically considerably heavier and slower to implement. In addition, the number of containers reserved for baggage in an aircraft is not at all tightly limited, so that, for example, the use of one ‘extra’ container may not mean anything to the loader, except to make his own task easier. In many aircraft types, there is also specific hold space for carrying loose baggage, so that even in a situation, in which the containers available for baggage really do run out in the middle of loading, a reasonable amount of baggage can be transported to the aircraft in baggage carts intended for loose goods. In addition, the statistical nature of the phenomenon leads to the fact that the last container or containers of those to be packed into a single aircraft load always remain partly empty. Thus, in practical terms, it is advantageous for automatic packing to be used to achieve only a so-called sufficient average degree of filling. On the other hand, if automatic packing can be used to achieve a degree of filling that is statistically significantly higher compared to manual packing, this should be taken into account in transport planning, because when large volumes are considered operating in this way will save having to return to the owning airline at least some of the empty containers that would otherwise be flying around the world.

In the loading method according to the invention, the principle of the average degree of filling is used and the air-transport units are loaded using devices with economical manufacturing and installation costs, smart sensors and computation algorithms supporting and controlling their operation, as well as efficient packing methods, in such a way that the air-transport units are loaded computationally sufficiently full. This is because, in the method, the filling of the transport units is facilitated by tilting them relative to the necessary degrees of freedom that are useful in terms of increasing the efficiency of the packing event, in such a way that the baggage is packed clearly faster, more directly, and to a higher degree of filling than if the transport unit is stationary and in a vertical position during the packing event, as in the known solutions.

In particular, in the method according to the invention, piece-goods and an air-transport unit, on at least one side of which is an openable loading opening, are transported to the loading location, when the piece goods are packed automatically through the loading openings into the air-transport unit. The air-transport unit is tilted in connection with packing, in such a way that the side with the loading opening is raised relative to the opposite side, so that the air-transport unit is loaded in at least two different positions.

According to one embodiment, the air-transport unit is manipulated in several degrees of freedom and backwards and forwards relative to at least one degree of freedom, in order to compact the pieces inside the air-transport unit and to increase the stability of the totality (stack) they form.

More specifically, the loading method according to the invention is characterized by what is stated in the characterizing portion of Claim 1.

A corresponding result can also be achieved using the loading system according to the invention, which comprises means for bringing piece goods to the loading location, means for bringing an air-transport unit to the loading location, and means for packing the piece goods into the air-transport unit through its loading opening. In addition, the system comprises means for manipulating the air-transport unit, in such a way that the air-transport unit can be manipulated to be loaded in at least two different attitudes.

More specifically, the loading system according to the invention is characterized by what is stated in the characterizing portion of Claim 10.

Significant advantages are achieved with the aid of the invention. By automating the loading stage, in a manner that is advantageous in terms of packing and the packing result, but economical in terms of the manufacturing, installation, and operating costs for the solution used for this, it will be possible to replace manual handling of baggage, which is slow and expensive and endangers work safety and work health. This will reduce airport personnel costs significantly. In fact, the use of one of the possible automation solutions according to the invention can replace the work input of five people, signifying a direct improvement in profitability. On the other hand, automation reduces the possibility of work-related injuries and improves airport reliability. Above all, automation increases capacity and accelerates the loading process, to the benefit of both customers and airlines.

Due to the cost-effective manufacturing and installation method of the system, the loading method according to the invention can be applied to both new and old airports, as only minor alterations are required to the existing infrastructure. One of the greatest challenges of the baggage-packing automation solutions presented in the literature and implemented in practice is that their introduction requires significance alterations to airport infrastructure—often even building baggage transport and sorting equipment from the very start around the packing-robot cell. In addition, if the invention is taken into account already in the design stage of the construction of new baggage-handling accommodation, it will be possible to operate with considerably smaller baggage-handling accommodation that at present, because an automatic packing system implemented in the manner disclosed by the invention will need significantly less space or floor area, even as little as less than 50%, in order to achieve a packing capacity corresponding to that of existing solutions. Depending on the case, the savings arising from building costs alone can be greater than the costs arising from the introduction of automatic packing.

Because, with the aid of the method, the air-transport units can be loaded to an even degree of filling, the aircraft will also be loaded evenly, in which case the even weight distribution will have a favourable effect of the aircraft's fuel economy. This is because by weighing each bag handled, the precise weight and even the weight distribution of each air-transport unit will also be known. The use of precise weights when calculating an aircraft's weight distribution has a favourable effect of the aircraft's fuel economy, especially on long flights.

In addition, in connection with automatic packing, it is easy to implement imaging of the location of each bag in the container, so that if necessary the removal of a specific bag from an already loaded aircraft—or from a container or baggage cart awaiting loading—will be accelerated and facilitated, because its appearance and location based on digital imaging can be transmitted to the personnel responsible for loading the aircraft, for example as an MMS message to a cell phone, or using some other known methods to some terminal device suitable for the purpose and present in the system.

### BRIEF DESCRIPTION OF DRAWINGS

In the following, some embodiments of the invention are described with reference to the accompanying drawings, in which:

FIG. 1 presents a general top view of a loading system according to one embodiment,

FIG. 2 presents an air container being loaded, on the horizontal plane,

FIG. 3 presents the container of FIG. 2, when tilted,

FIG. 4 presents the container according to FIG. 3, which is being loaded on a tilted feed conveyor,

FIG. 5 presents a loading diagram according to one embodiment,

FIG. 6 presents a process diagram according to one embodiment,

FIG. 7 presents an isometric illustration of a loading system according to one embodiment of the invention, in which the container is tilted at about 45 degrees,

FIG. 8 presents the loading system according to FIG. 7, when the container is tilted at about 90 degrees,

FIG. 9 presents the loading system according to FIG. 7, when a full container on the horizontal plane has been rotated around its vertical axis by about 45 degrees,

FIG. 10 presents the loading system according to FIG. 7, when a full container on the horizontal plane has been rotated around its vertical axis by about 90 degrees,

FIG. 11 presents an isometric illustration of a loading system according to a second embodiment of the invention, when the container is on the horizontal place,

FIG. 12 presents the loading system according to FIG. 11, when the container is tilted at about 45 degrees,

FIG. 13 presents the loading system according to FIG. 12, from another direction,

FIG. 14 presents the loading system according to FIG. 11, when a full container on the horizontal plane has been rotated around its vertical axis by about 45 degrees,

FIG. 15 shows the loading system according to FIG. 11, when a full container on the horizontal plane has been rotated around its vertical axis by about 90 degrees, to be fed onto a cart,

FIGS. 16 and 17 present a loading system according to one embodiment, the loading cell of which is equipped with a buffer store, and

FIG. 18 presents a loading system according to one embodiment, the air-transport unit handling device of which is arranged to manipulate an air-transport unit in several degrees of freedom.

### DESCRIPTION OF EXEMPLARY EMBODIMENTS

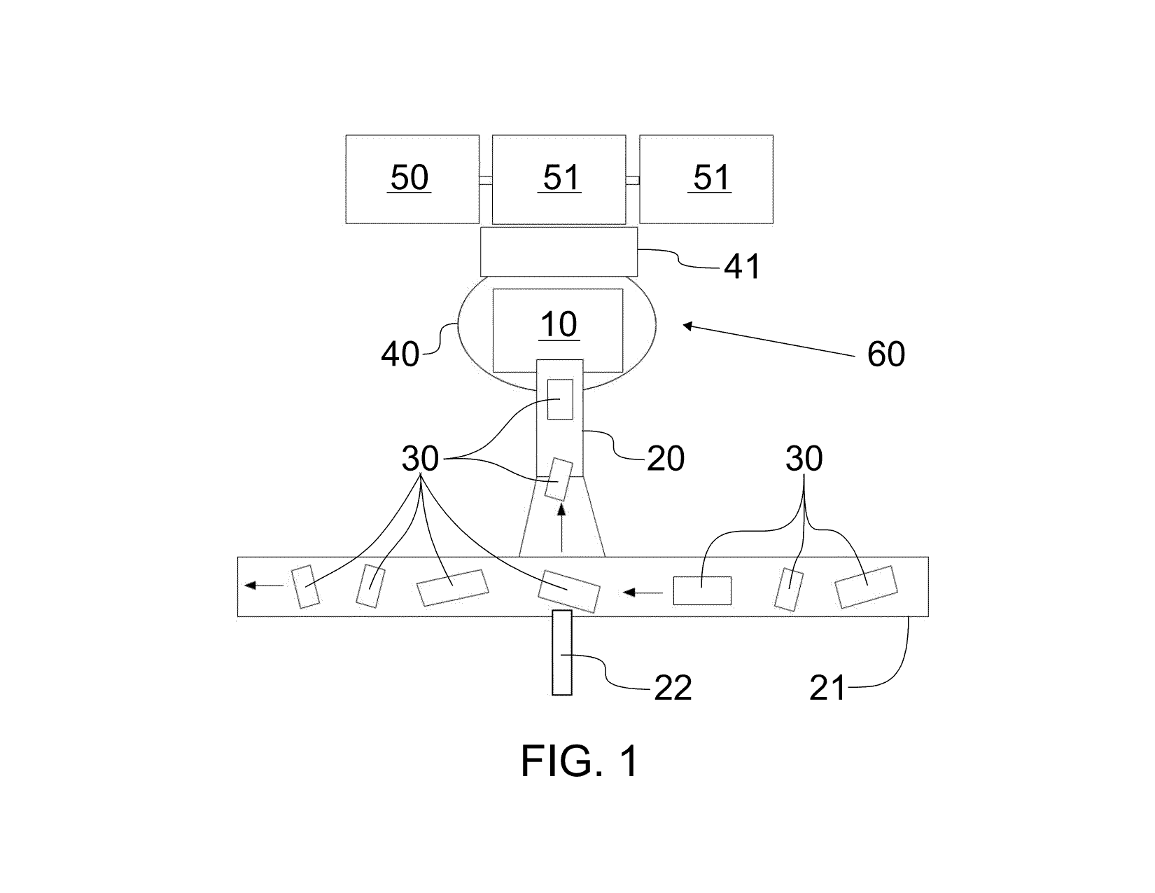

FIG. 1 shows a top view of a loading system according to one embodiment of the invention, in which pieces 30 are transported to the loading cell 60 on a main conveyor 21. The main conveyor 21 is a belt or slat conveyor, widely used in automatic baggage-handling systems in airports. The pieces 30, such as packets or bags or similar, are equipped at check-in with an identifier, such as a barcode sticker or an RFID identifier, on the basis of which the correct piece 30 is picked off the main conveyor to the loading cell 60, for loading into an air-transport unit 10. The air-transport unit 10 can be an air container, or a baggage cart, or some other transport module used in air traffic. In this connection, an air-transport unit 10 is examined in the special case of an air container.

The separation of the correct pieces 30 from the rest of the material flow is based on a separator 22 operating on the basis of identifiers. In its simplest form, the separator 22 is an actuator-type buffer, which is arranged to push the correct piece 30 along a feed channel into the loading cell 60. The separator 22 is connected to the automatic goods-handling system of the airport infrastructure, which gives the separator 22 a pushing command, based on the piece's 30 identifier. The creation of a separator 22 and a material control system like those described is, as such, known. The separators 22, main conveyors 21, and other components that are, as such, known, which are essential when sending the pieces 30 to the loading location, form the means for bringing piece goods 30 to the loading location.

It will further be seen from FIG. 1, that the pieces 30 are loaded into an air-transport unit 10 at the loading cell 60. According to one embodiment, the pieces 30 are loaded into the air-transport unit 10 using a simple feed conveyor 20, which will be examined in greater detail later. However, in general the pieces 30 are loaded into the air-transport unit 10 using means for packing piece goods into an air-transport unit, but for reasons of clarity the means will be referred to in the following using the expression feed conveyor, which is one embodiment of the said means.

The air-transport unit 10 is arranged in a handling device 40, which is arranged to place the air-transport unit 10 into the correct position and attitude to receive the pieces 30. The handling device 40 is also referred to by the expression means for manipulating an air-transport unit. The construction and operation of the handling device 40 will be examined in detail later. The air-transport unit 10 is brought to the loading cell 60 on an automated conveyor, such as a belt conveyor. The loaded air-transport unit 10 is moved by a transfer device 41 from the loading cell 60 to a cart 51 for transport to the aircraft. The transfer device 41 can form its own handling unit, or it can be part of the handling device 40. The carts 51 are typical carts used in airports and towed by a tug 50, by means of which containers, loose pieces, or similar goods are transported from the terminal's technical accommodation to be loaded into the aircraft. Alternatively, the loaded air-transport units 10 can be moved for loading into the aircraft by other means, such as trucks.

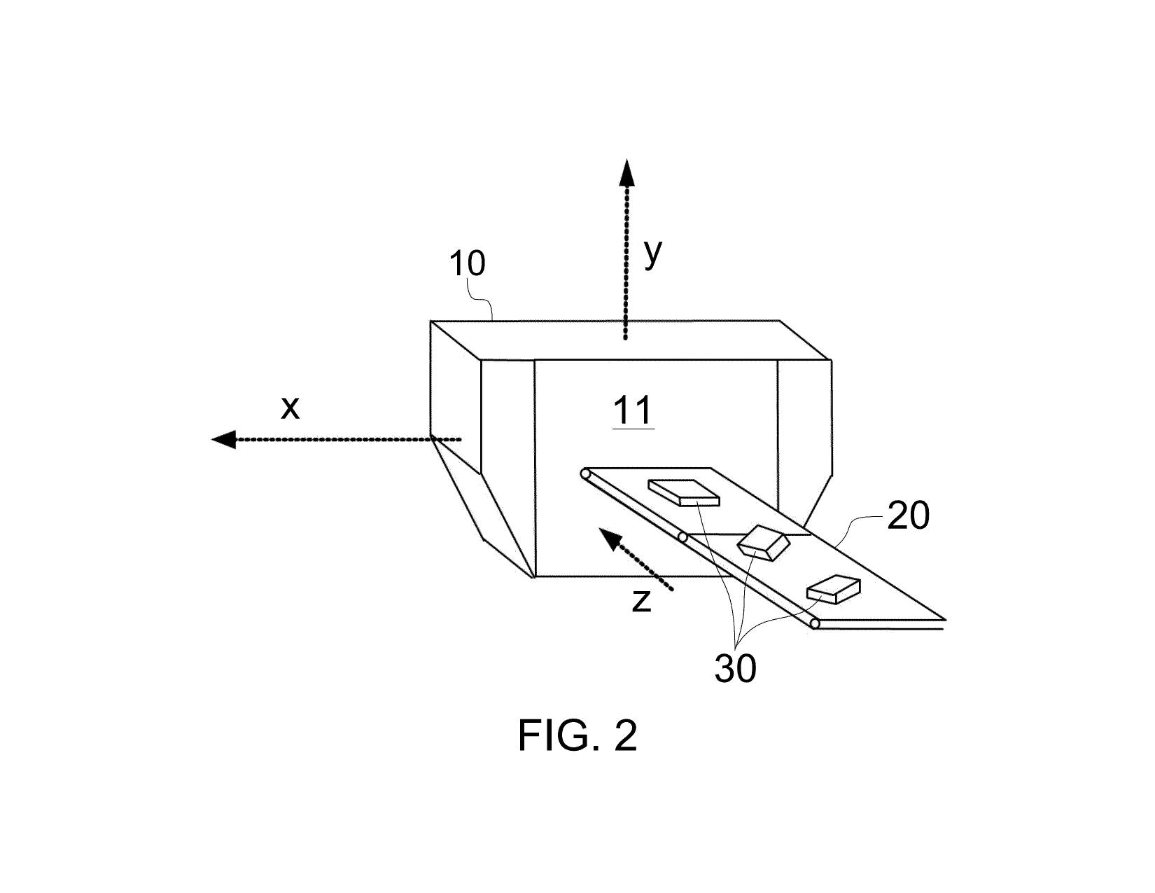

FIG. 2 shows the initial stage of the loading of the air-transport unit 10 in greater detail, in which an air container is loaded according to one embodiment. In the initial stage of loading, the air container 10 is brought to the loading cell 60 (FIG. 1), at which point it is ensured that the loading opening 11 of the air container 10 is open. The loading opening 11 can be left open at the stage of emptying the container, or its opening can be arranged automatically, for example, using remotely controlled grabs. The air containers 10 themselves are standardized air-transport units, which are particularly advantageous units in terms of the invention, as the uniform shape permits simple handling automation. In the initial stage of loading, the loading opening 11 in the side of the air container 10 is in a vertical position (direction y), or alternatively slightly tilted (direction y), when the piece goods 30 are loaded using a transverse (direction z) feed conveyor 20. In its simplest form, the feed conveyor 20 can be a belt conveyor, a slat chain, or some other means used in automated piece-goods handling systems for moving the pieces. Alternatively, the feed conveyor 20 can be a robot or a manipulator. Loading is continued in the horizontal position parallel to direction z, during which the degree of filling of the container is monitored. Monitoring of the degree of filling is implemented, for example, using a capacitive approach switch, or some other suitable manner, by means of which information is created of the surface height of the piece-goods stack, and the information is transmitted to the control system.

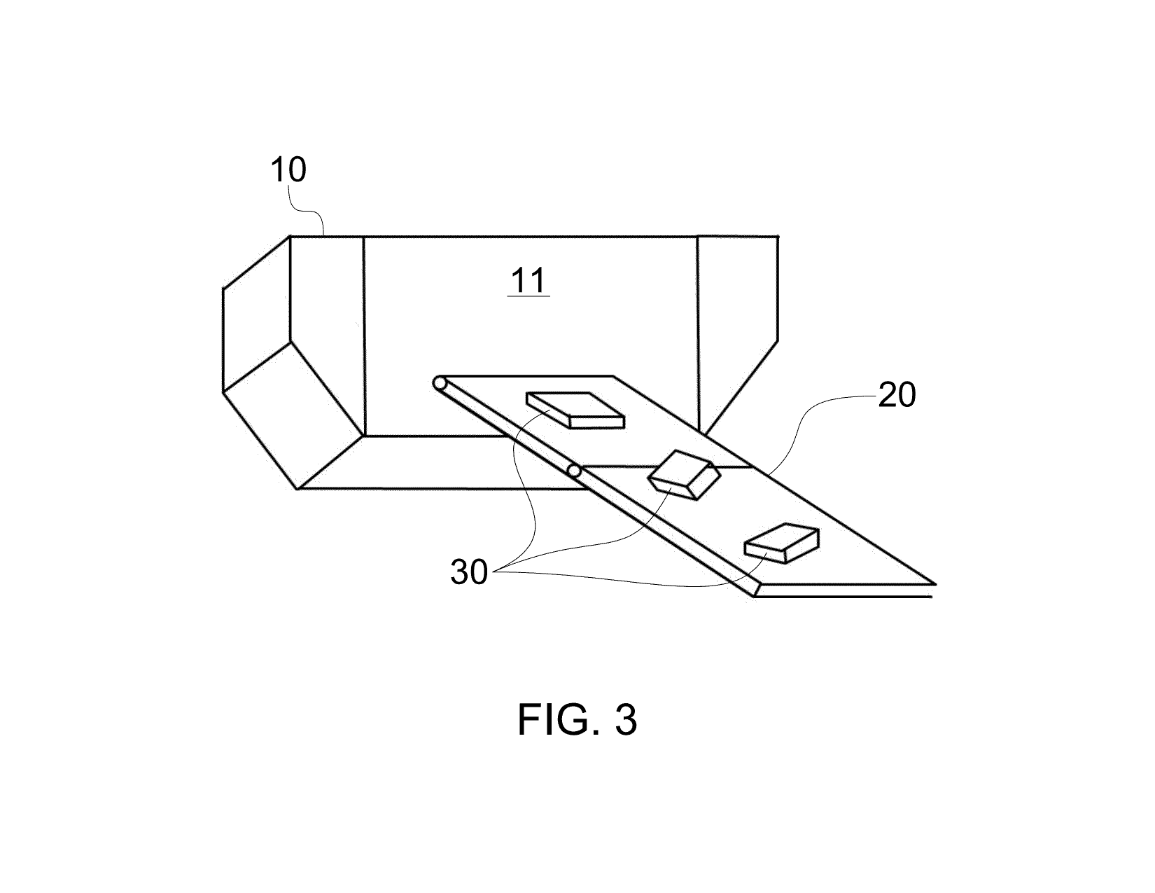

Once the target degree of filling exceeds a limit value, the container 10 is begun to be tilted relative to the horizontal axis x (FIGS. 2 and 3). As the container 10 tilts, the loading opening 11 rises higher in the y direction than the opposite side. Loading and monitoring of the degree of filling are continued and the attitude of the container 10 is further altered, in such a way that the bottom 12 of the container 10 rises towards the vertical position and the loading opening 11 towards the horizontal position. Thus, the container 10 is first of all loaded from the side and after rotation from above, using the same loading opening 11 in different positions. Rotation can be performed in one or in several stages, so that each rotational movement makes the pieces 30 already loaded become more even in the container.

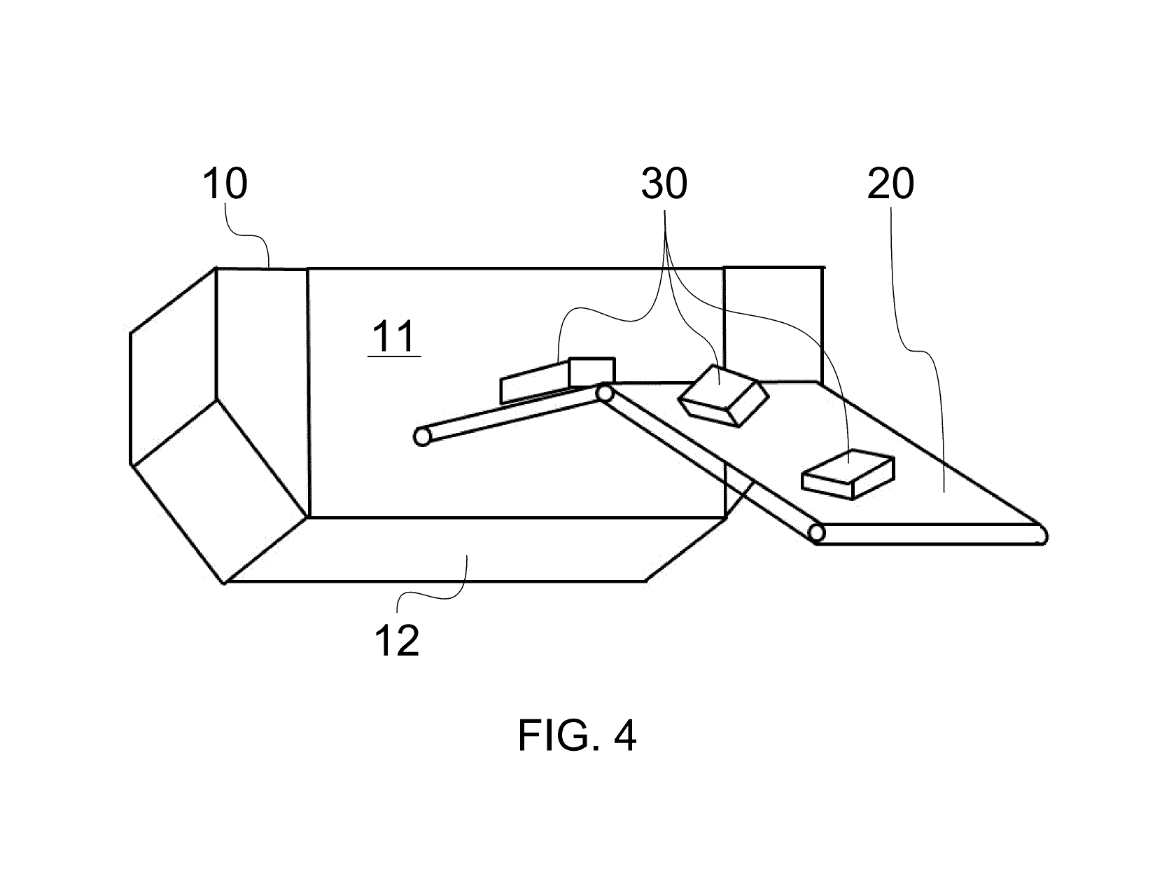

When the container 10 is filled and tilted, the feed conveyor 20 is also aligned in such a way that the container 10 fills as evenly as possible. For example, the feed conveyor 20 can be aligned in the manner shown in FIG. 4, in which the pieces 30 are dropped over the entire area of the loading opening 11. When the container 10 is tilted, the stacks already created are in no danger of falling out of the loading opening 11, the piece stack being supported instead on the rear wall of the container 10, i.e. on the side opposite to the loading opening 11. When the degree of filling detector notifies that the container is sufficiently full, loading of the pieces 30 is interrupted and the loading opening 11 is closed. Closing is carried out automatically or manually in connection with changing the container. In this stage, the container 10 is tilted around axis x, when it is in an attitude differing from the initial situation. Thus, the container 10 is rotated to the correct attitude for the automatic container-handling device, or the container 10 is transferred to a cart 51 by a transfer device 41 (FIG. 1). The closed container 10, which has been turned the right way round, is then transported to the aircraft and loaded into its hold.

In the automated loading of an air-transport unit 10, the tilting possibility permits, if necessary, the utilization of not only many different algorithms based on sensor or imagining information, but also of quite simple loading algorithms. This is because measurements performed at an example airport have shown that, when loading, for example, standard air containers manually, an average of 32 bags is loaded into the container. Naturally there is deviation in both the size of the bags and especially in the degree of filling of the containers, but on average it is sufficient to load 32 average bags or other pieces into each container. However, in practice it happens that the loaders load the first container with more bags that the average value, so that the last container remains partly filled. Thus the filling surface area of the air-transport unit 10, such as the bottom of an air container, can be divided into loading locations according to the average value.

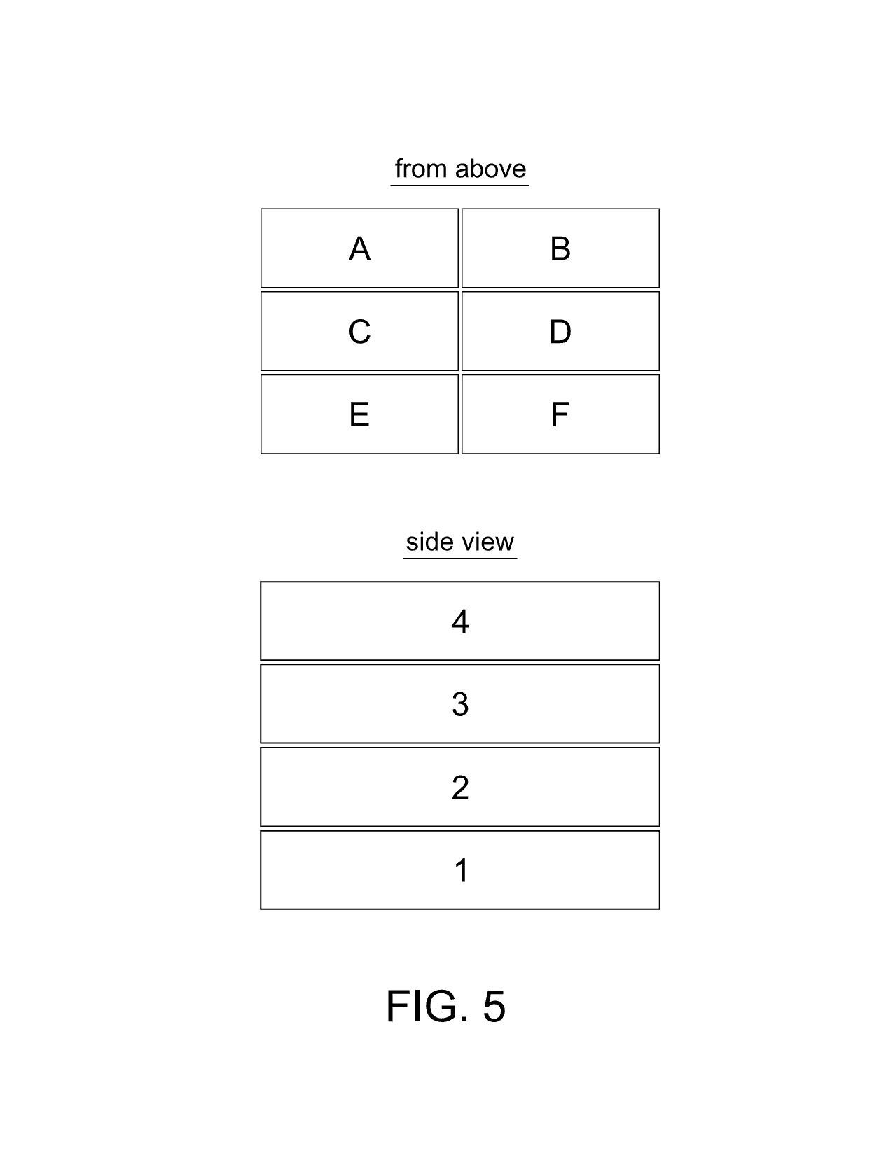

The AKH air container widely used as an air-transport unit 10 in air traffic will be examined as one embodiment. It has been observed that the average for the air container in question is 32 bags. However, in the following an example of a container will be examined, in which the number of pieces is 24 pieces, which can be divided as six parallel bags in four layers. Thus, the filling image shown in FIG. 5 is obtained. The filling image could equally well be made for 32 or more bags or images and/or the layer number varied for some other number of pieces. It can be seen from FIG. 5 that each layer comprises locations A . . . F, in such a way that A is the loading location on the left farthest from the loading opening and F is the loading location on the right nearest to the loading opening. It can also be seen from FIG. 5 that the first layer is lowest and the fourth layer is the uppermost.

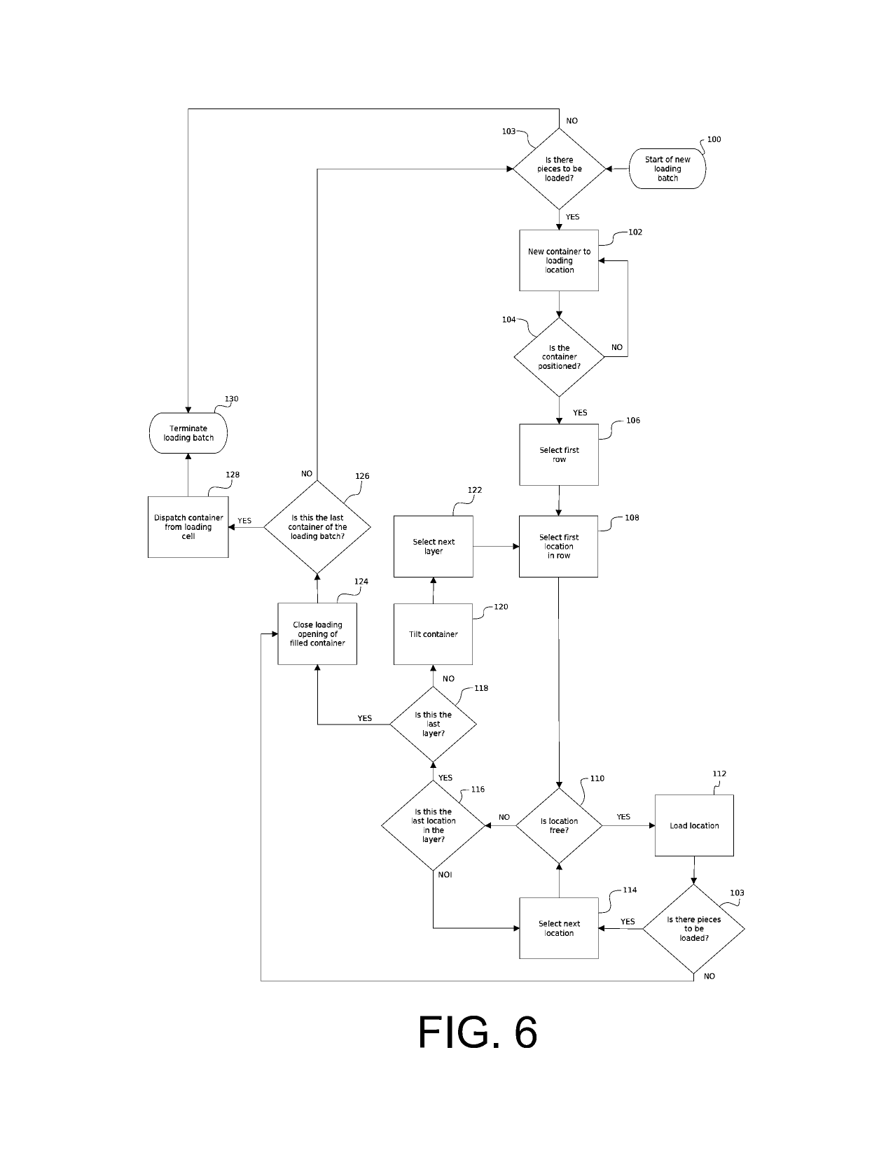

According to FIG. 6, the loading process for each loading batch starts with a command being received from the airport's material-control system to commence the loading 100 of a new loading batch. At first, a check is naturally made as to whether pieces 103 for loading are coming at all to the loading batch in question. If not, the loading batch is terminated 130. Otherwise, a new air-transport unit 10, in this case an air container 102, is brought to the loading cell 60. The presence sensors (not shown) fitted to the loading cell sense whether the container is in the correct location and the correct attitude for loading 104. If the container is not in the correct location, loading does not start, instead the positioning of the container is fine-tuned, until loading can commence.

Once the container is in the correct location, the first layer 106 is chosen, when the feed conveyor 20 brings the pieces 30 to the correct height relative to the container for transfer to the container. After this, the first location 108 of the layer is selected, when the feed conveyor 20 moves to the first location A. In this connection, a separate presence sensor of the feed conveyor 20 or the loading cell 60 senses whether the location is free 110. If the selected location is free, i.e. there is no previous piece 30 in it, the feed conveyor 20, 112 loads the piece 30 into the selected location. After loading, a check is made for other pieces still to be loaded in the loading batch 103. Alternatively, a check can be made as to whether pieces to be loaded are still on the conveyor coming to the loading cell, if the material-control system sends the pieces to be loaded automatically to the cell in question. If there are no more pieces to be loaded, the container is closed 124 and the process continues in manner described hereinafter. Otherwise, the next location is selected, in this case location B. Next a check is made on the basis of the senor information collected in connection with the previous loading movement, as to whether a new location is free. The same process is continued in the selected layer, for example, in the order A, B, C, D, E, and F.

If the selected location is not free 110, a check is made 116 as to whether the selected loading location is the last location F of the selected layer. If it is not, but for example the selected location C is taken up, a move is made to the next location. This can happen if, for example, the piece loaded into location A is so large piece that it comes into the area of location C. If the selected location is the last (F) in the layer, a check is made 118 as to whether the selected layer is the last layer 4 of the container. If it is not, the container is tilted 120, after which the next layer, in this case layer 2, is selected. According to the invention, the container or other air-transport unit 10 can be tilted in several different ways. According to one embodiment, the air-transport unit 10 is tilted by 90 degrees, once more than half of the intended number of pieces has been loaded into the container. According to the embodiment shown in FIG. 6, the container is tilted after each layer. Thus, the container is tilted three times, so that each time the container is tilted by 30 degrees. After the tilting of the container 120, a new layer is selected 122. A new location is selected from the new layer 108, when the new layer is loaded like the previous one.

However, if the last location F of the last layer 4 of the container is full 118, the loading opening 11 of the container is closed 124. After this, a check is made 126 as to whether the loaded container is the last in the loading batch. If the container is not the last in the loading batch, but instead more containers have been budgeted for the aircraft, a check is made 103 as to whether more pieces to be loaded belong to the loading batch. If there are no more, the loading batch is ended. Otherwise, the loading process begins over again with a new container. If this was the last container 126, it is taken away from the loading cell 128 for dispatch either to the aircraft or to an intermediate store. In this connection, the container can be tilted back to its original attitude. After this, the loading batch is terminated 130 and a message notifying termination of the loading batch is sent to the airport's material-control system.

Other sensoring can also be added to the process. For example, the degree of filling of a container can be monitored using a surface-height sensor. If it is noticed at some stage that the container is full, the container is tilted and a new measurement is made. The degree of filling can naturally be estimated, or measured in some other way, for example, using various kinds of calculators, imaging devices, scanners, sensors, or other ways used in industry. Once the container has been determined to be full, or computationally sufficiently full, the container is closed and the process moves to loading the next container. Otherwise, loading of the next layer begins.

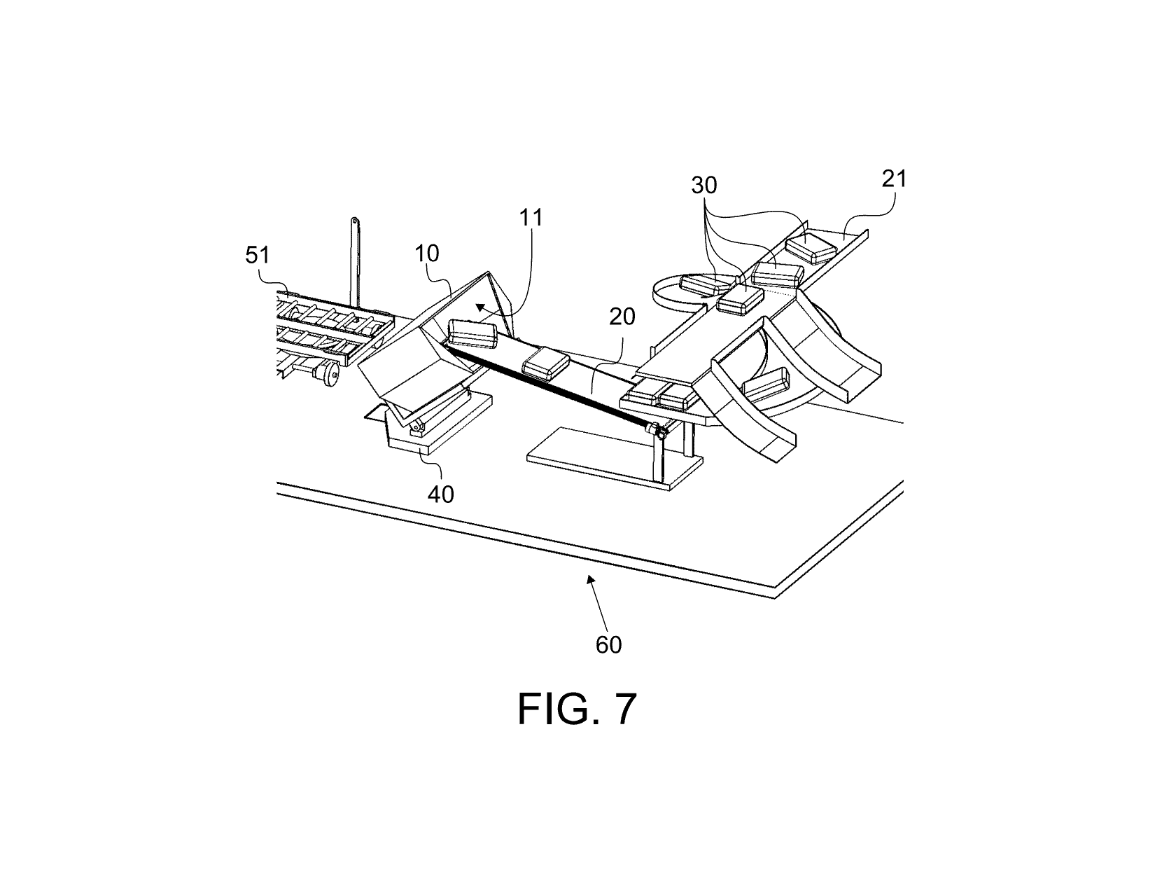

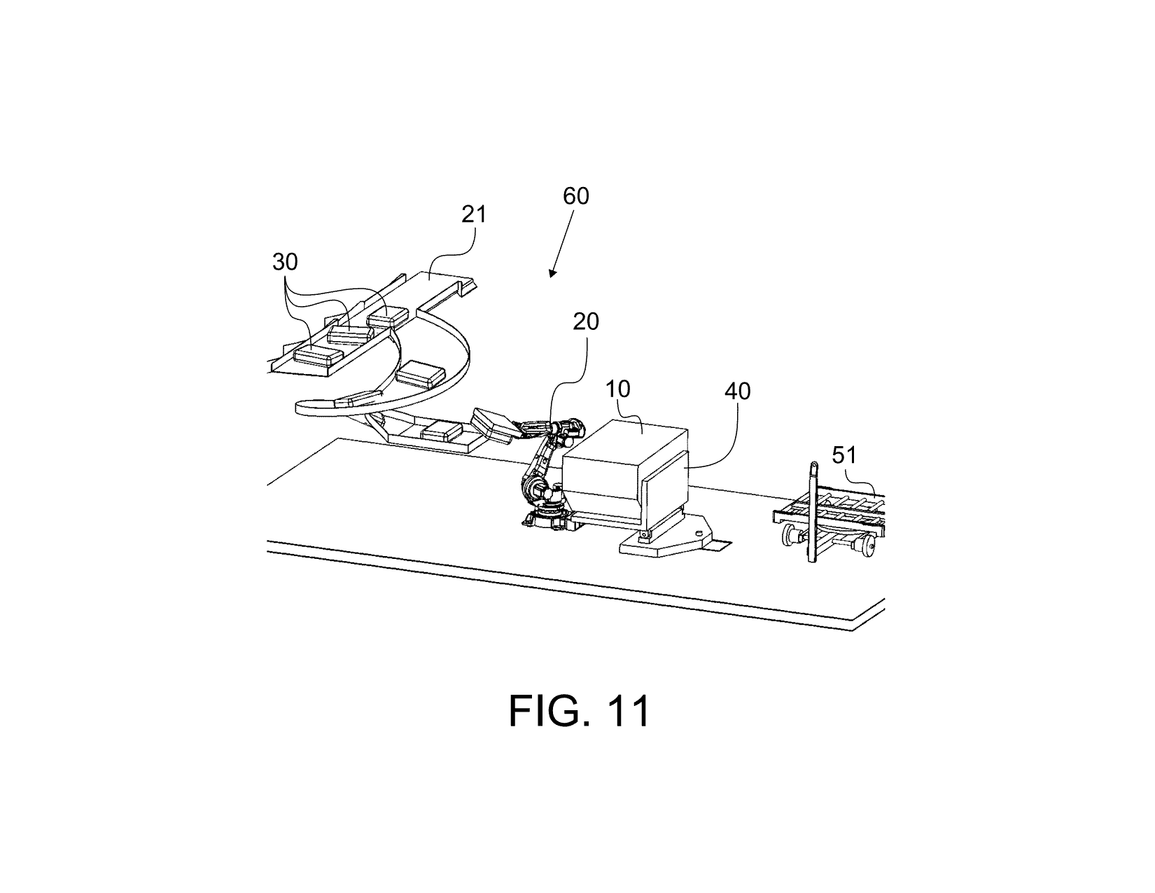

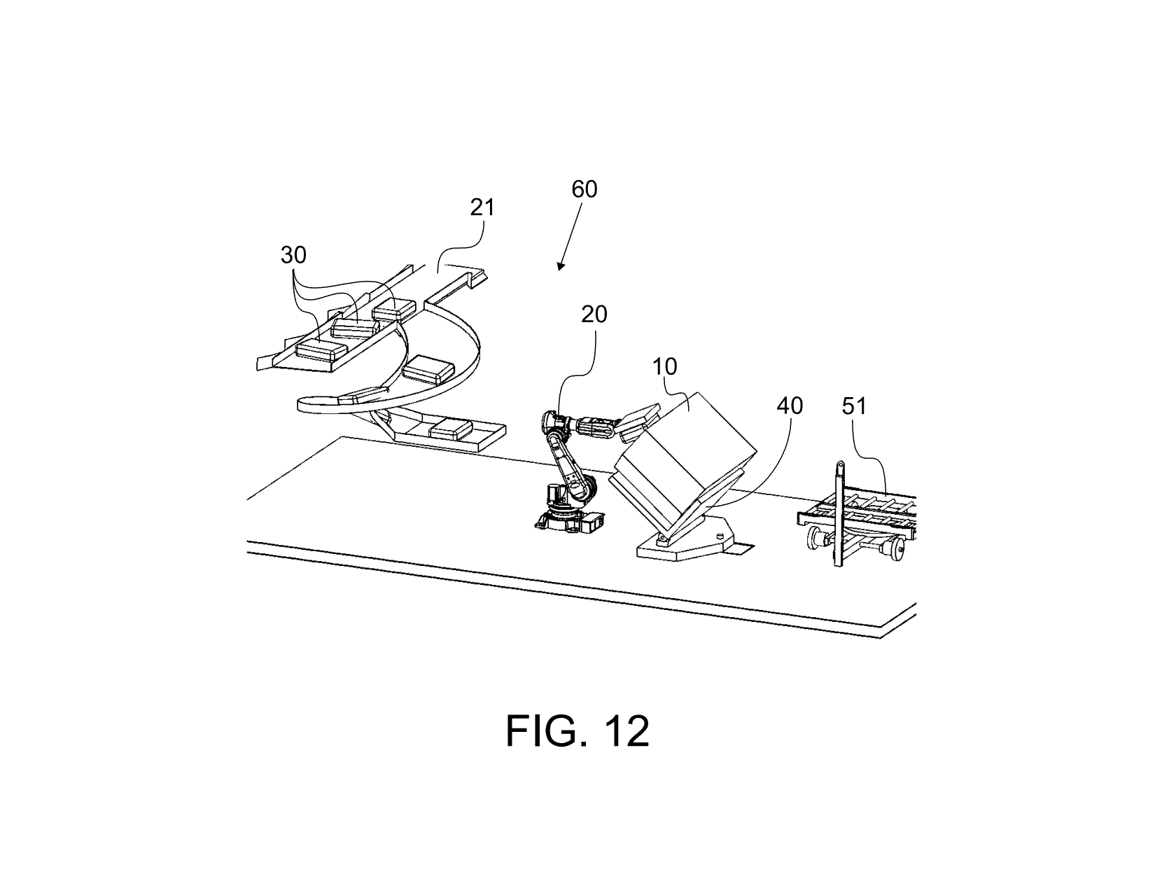

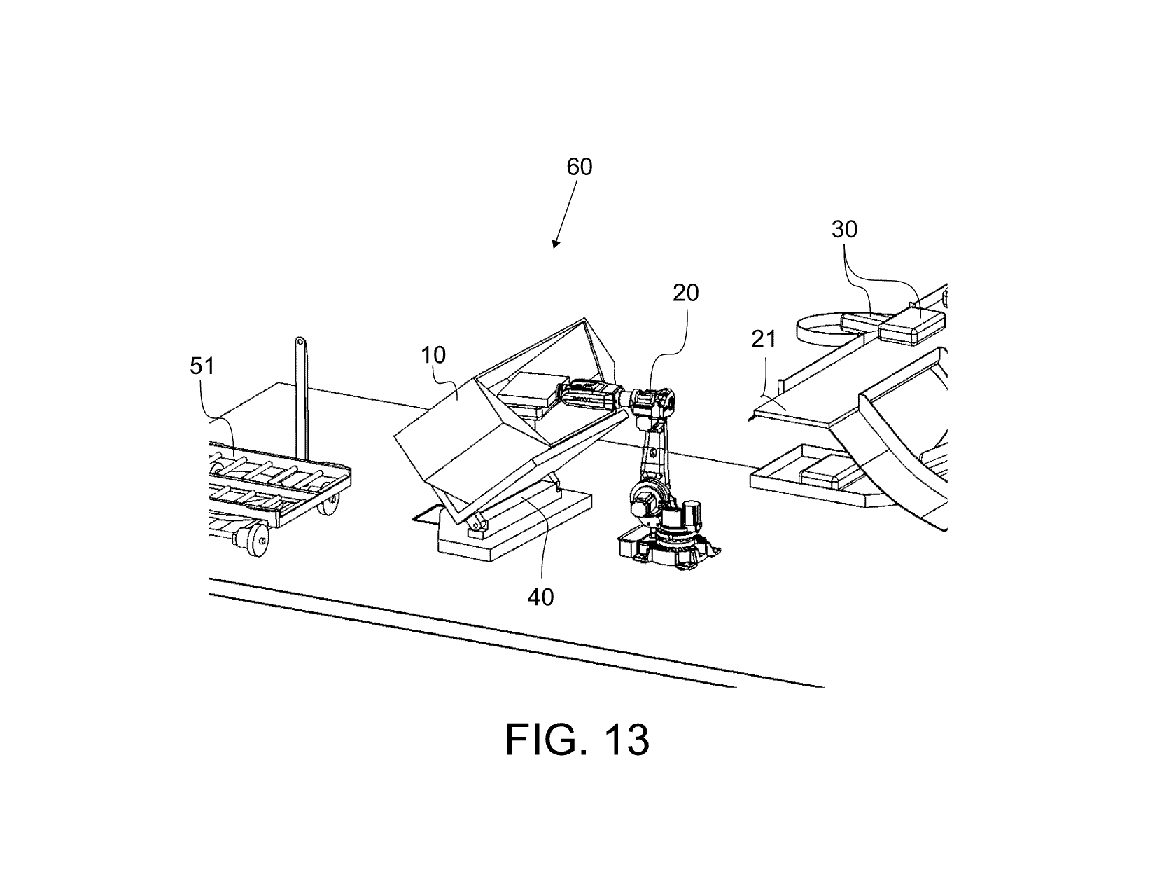

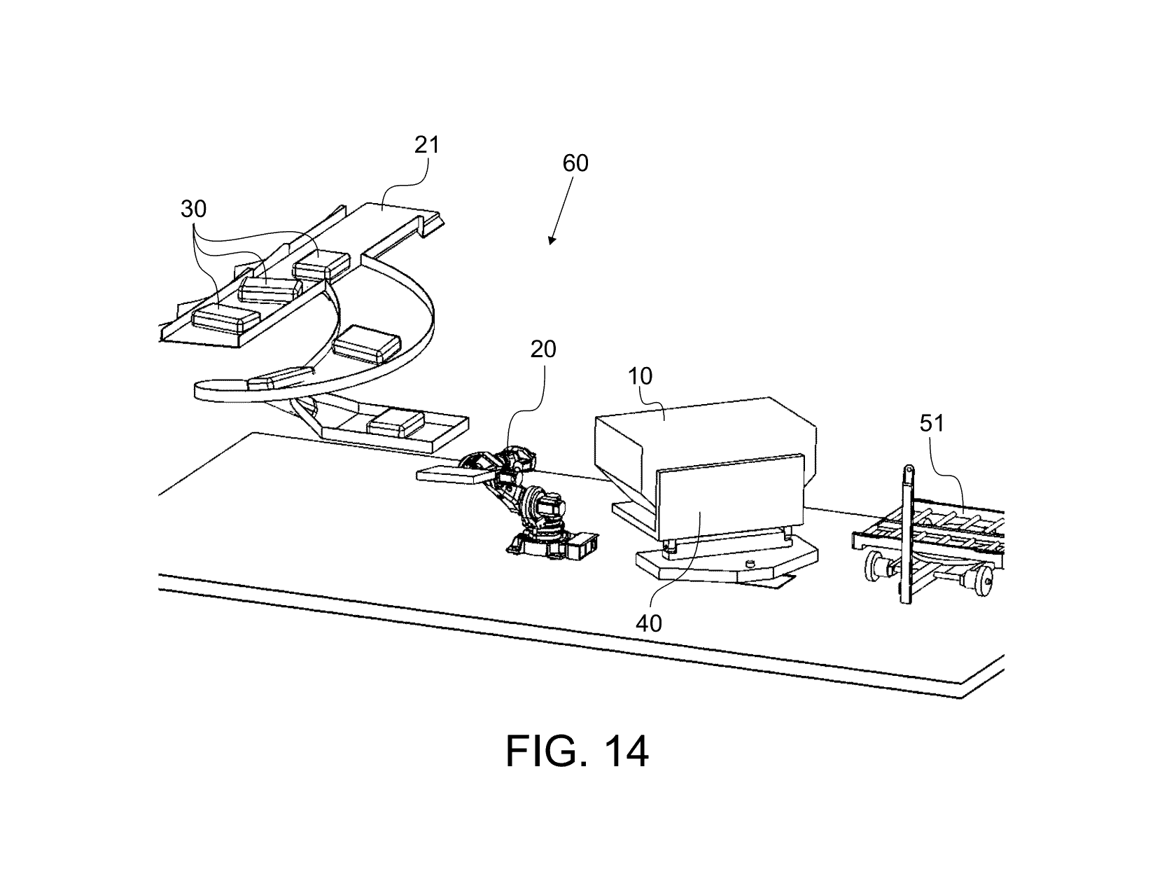

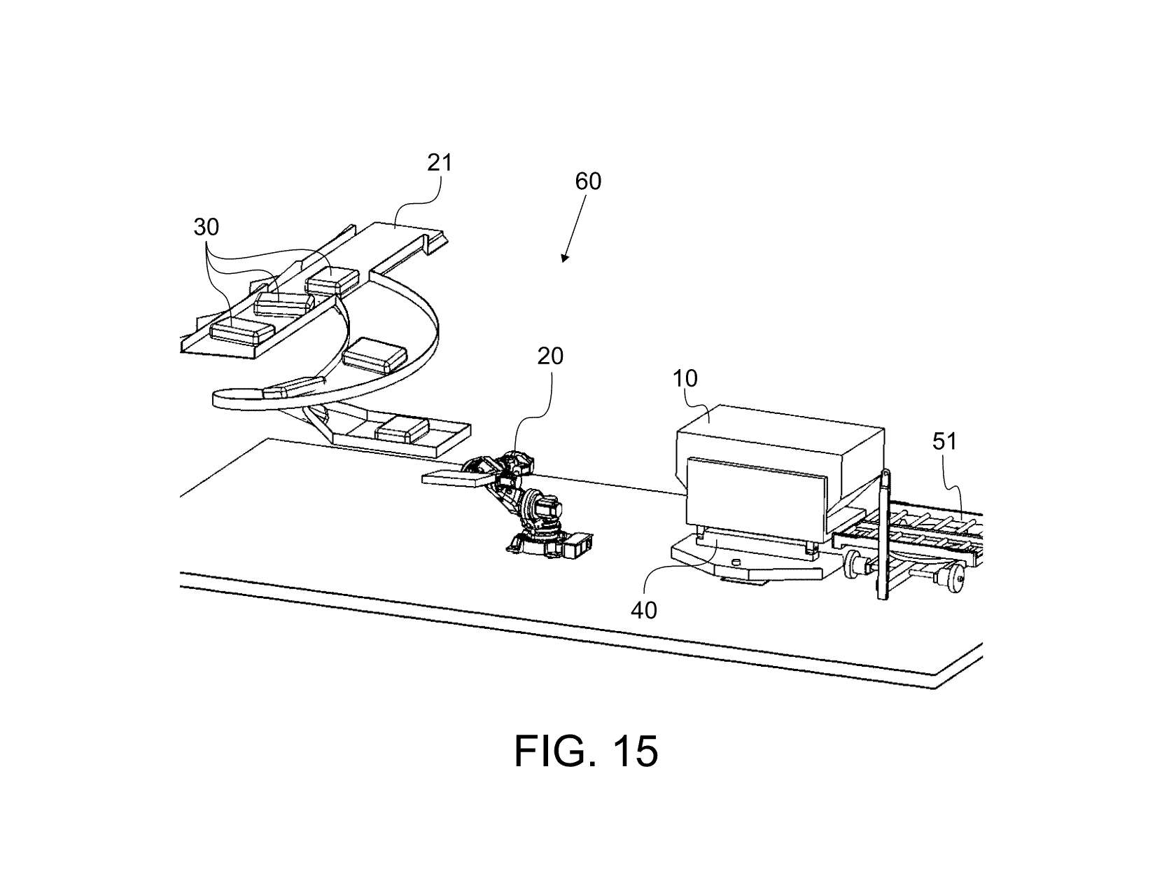

As stated, the loading system according to the invention can be implemented in many different ways. Thus, within the scope of the invention, the feed conveyor 20, for example, can be implemented in many different ways. FIGS. 7-15 show a loading cell 60, which, in FIGS. 7-10, is equipped with a simple tiltable belt conveyor and, in the embodiment shown in FIGS. 11-15, with a robot. According to the embodiment shown in FIGS. 7-10, the pieces—in this case the suitcases 30—are transported to the loading cell 60 by the main conveyor 21, from which a spiral chute, as such known in airports, leads to the loading cell. In the initial situation (not shown) the bags 30 are loaded into the air-transport unit 10 on, or close to the horizontal plane, by a belt conveyor 20 on the horizontal plane. When the degree of filling of the air-transport unit—in this case the air container 10—exceeds a set limit value, the container 10 is manipulated by tilting it in the manner described above, when the belt conveyor 10 is raised to a corresponding angle (FIG. 7). The tilting of the container 10 can be implemented continuously from the first bag 30, or in steps, always after reaching the limit value of a specific degree of filling.

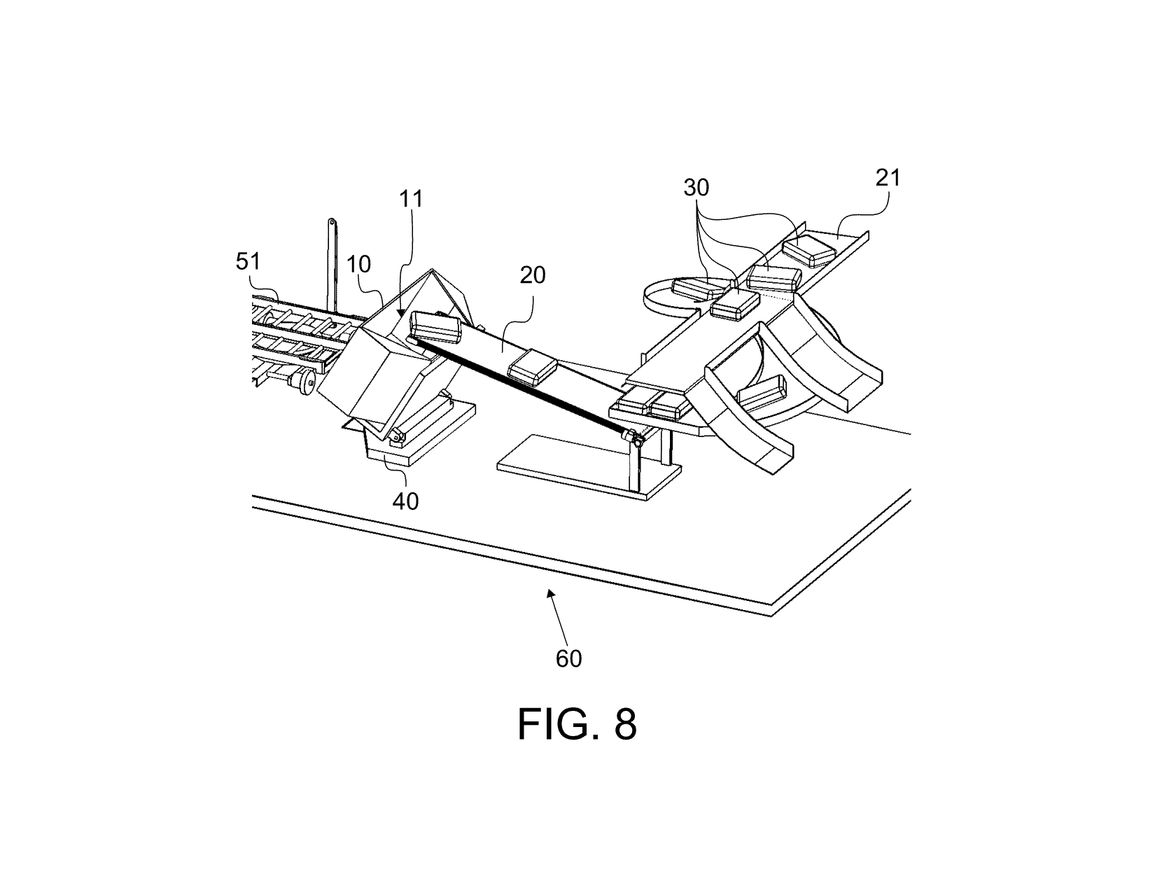

During loading, the container 10 is handled using a handling device 40, which comprises means for tilting the container 10 relative to at least one axis—in this embodiment, the horizontal axis. Thus, the handling device 40 can be simply an angled plane receiving the container 10, onto which the container 10 can be locked, and which can be tilted, for example, using pneumatic cylinders. As the degree of filling of the container 10 increases, it can be tilted farther (FIG. 8), thus ensuring the sufficiently efficient loading of the container 10. The belt conveyor can be equipped with an articulated joint or several degrees of freedom (not shown), with the aid of which the bags 30 can be distributed evenly in the container 10.

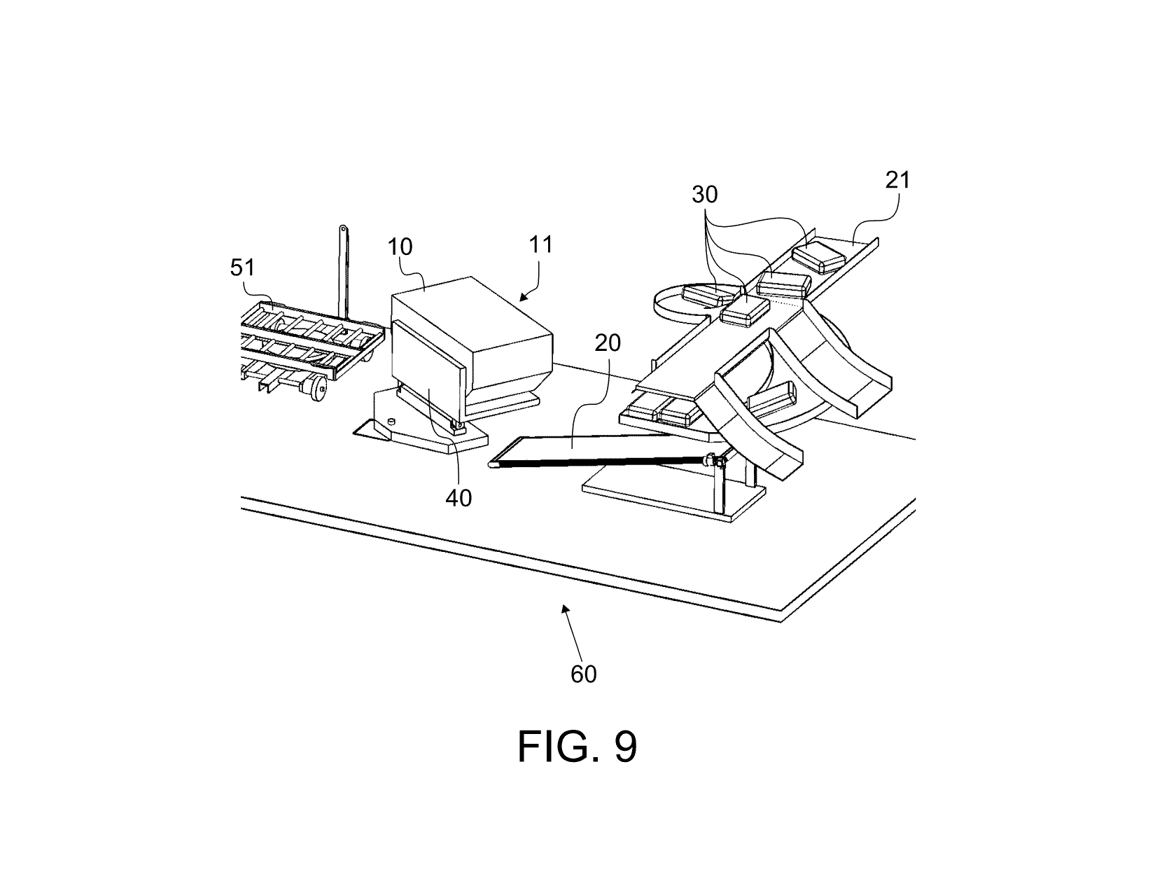

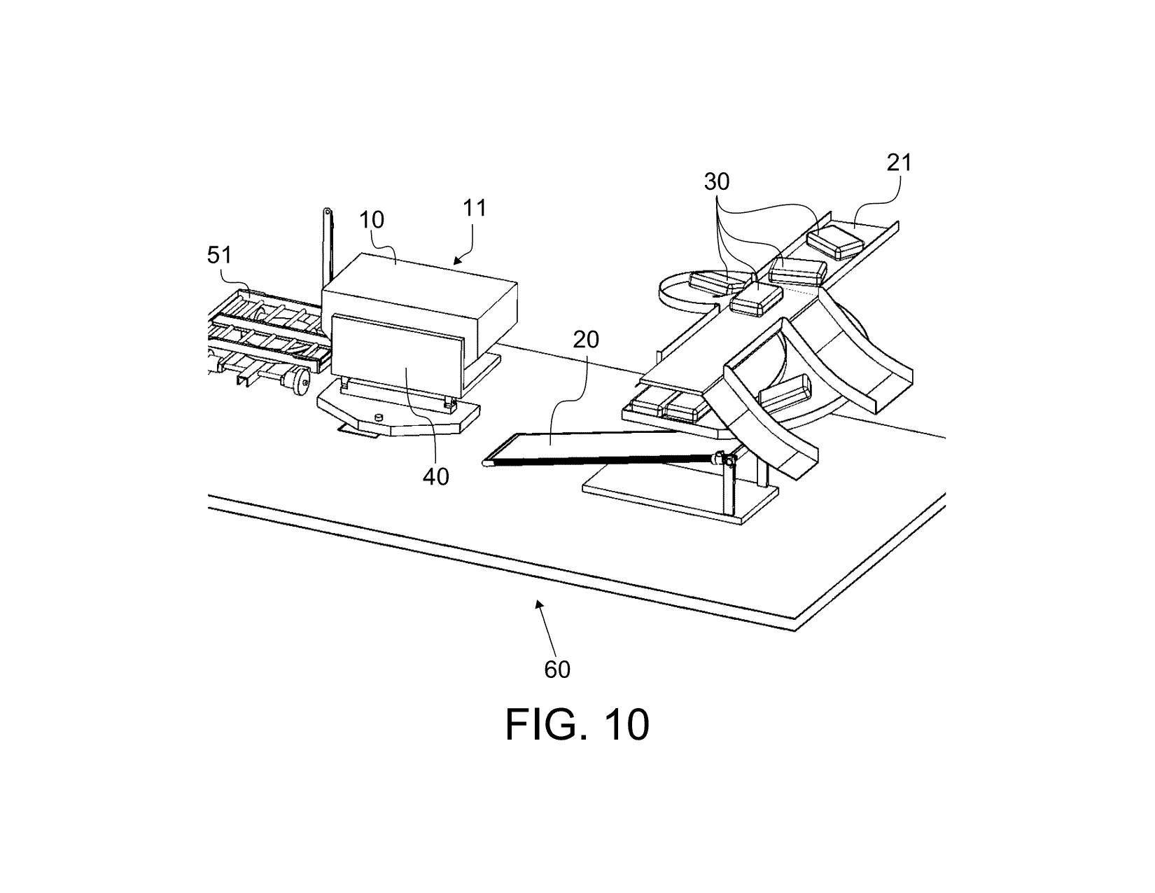

When the container 10 is sufficiently full, the loading opening 11 is closed and the container is tilted back to the horizontal plane. The handling device 40 is equipped with a manipulator (not shown), which is arranged to grip the container's closing tarpaulin and pull it down to close the loading opening 11 of the container. After this, the container 10 is rotated relative to its vertical axis, so that it can be fed onto a cart 51 (FIGS. 9 and 10). In fact, the container 10 handling device 40 is equipped with not only tilting elements, but also with a roller conveyor, or some other element, by means of which the container 10 can be fed to a receiving cart on the horizontal plane.

FIGS. 11-15 show a corresponding loading cell 60, in which the loading system is equipped with a robot 20, instead of a belt conveyor. With the aid of the robot 20, a slightly higher degree of filling can be achieved, but simultaneously the complexity of the system increases.

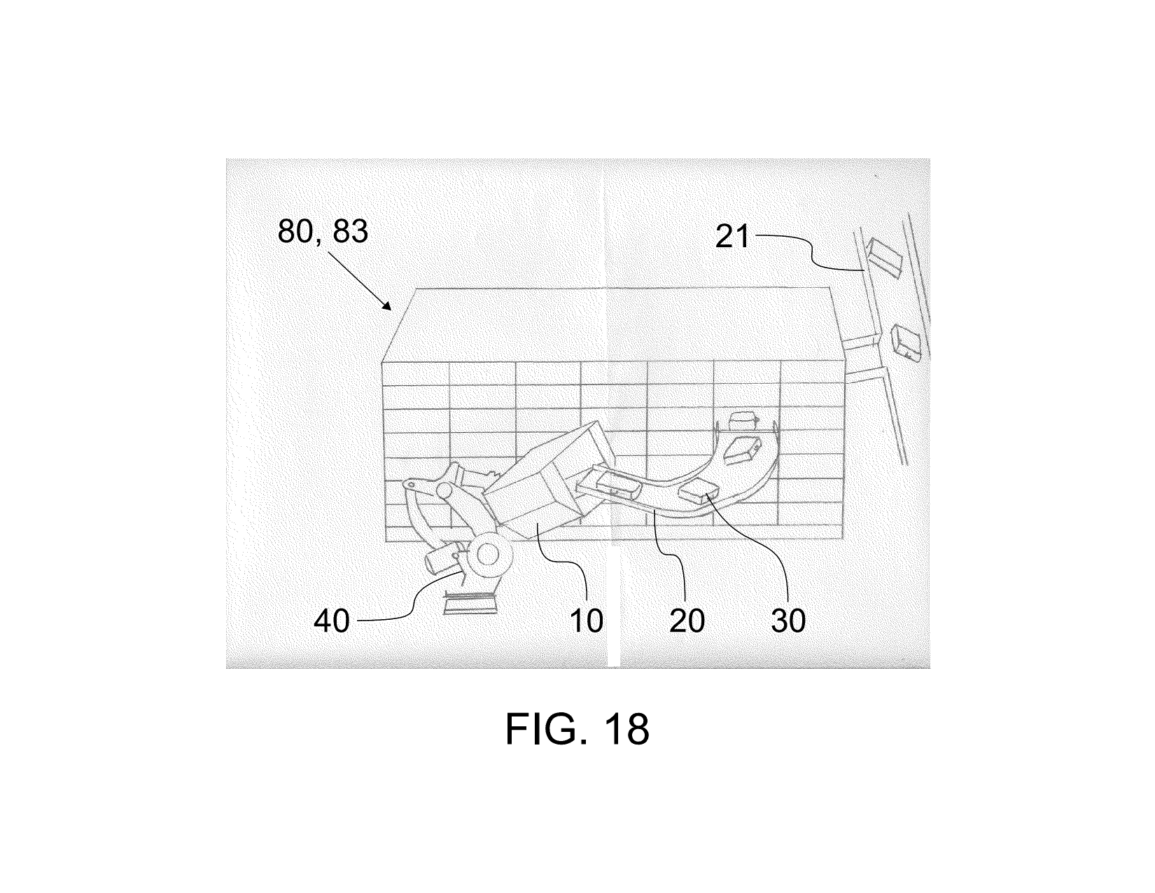

Embodiments are described above, in which the air-transport unit 10 is manipulated by a handling device 40 rotating relative to one axis. According to the invention, the handling device 40 can also be arranged to tilt the air-transport unit 10 relative to other axes, or degrees of freedom. In other words, the handling device 40 is arranged to tilt the air-transport unit 10 in at least one degree of freedom. According to one embodiment, the handling device 40 is a high-capacity industrial robot, which is arranged to grip the air-transport unit 10 and tilt it in several degrees of freedom (FIG. 18). The industrial robot can be, for example, a Fanuc M2000 model robot, which is able to handle a load of up to 1200 kg in six degrees of freedom. The robot equipped with a suitable grab can thus be adapted to rotate, for example, a fully loaded air container, in such a way that the container is brought to the feed conveyor 20 at a suitable angle. The feed conveyor can then be, for example, a simple belt conveyor.

A vibration function, in which the robot manipulates the air-transport unit 10 with a small motion deviation at a high frequency, when the pieces 30 will settle evenly into the unit 10, for example, can be easily applied to an arrangement like that described. The backwards and forwards manipulation can take place in one or more directions. The pieces 30 will then settle either into a more stable order, or more compactly relative to each other, or in such a way that the air-transport unit 10 can be filled fuller than by placing the pieces 30 on top of each other in the traditional methods.

In general, the air-transport unit 10 can be manipulated by tilting, vibration, or using some other suitable movement, or by some combination of these.

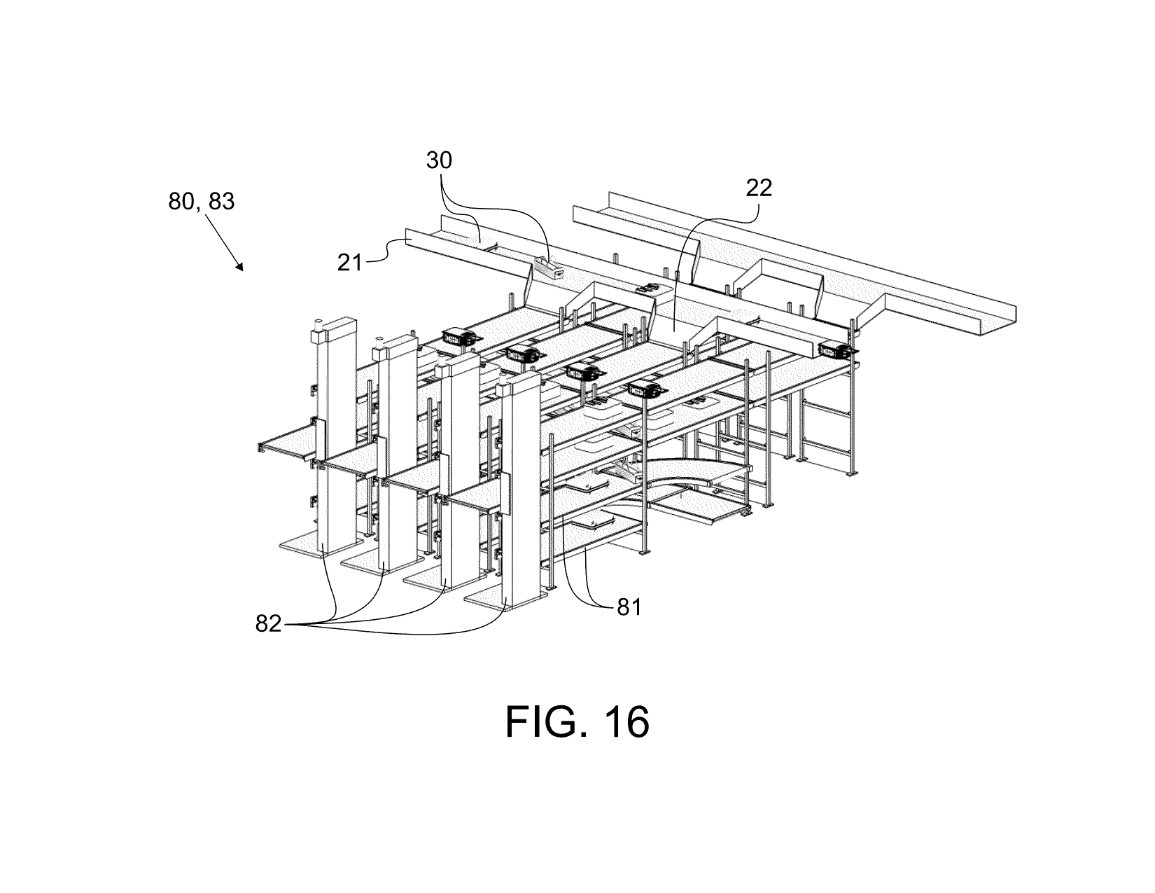

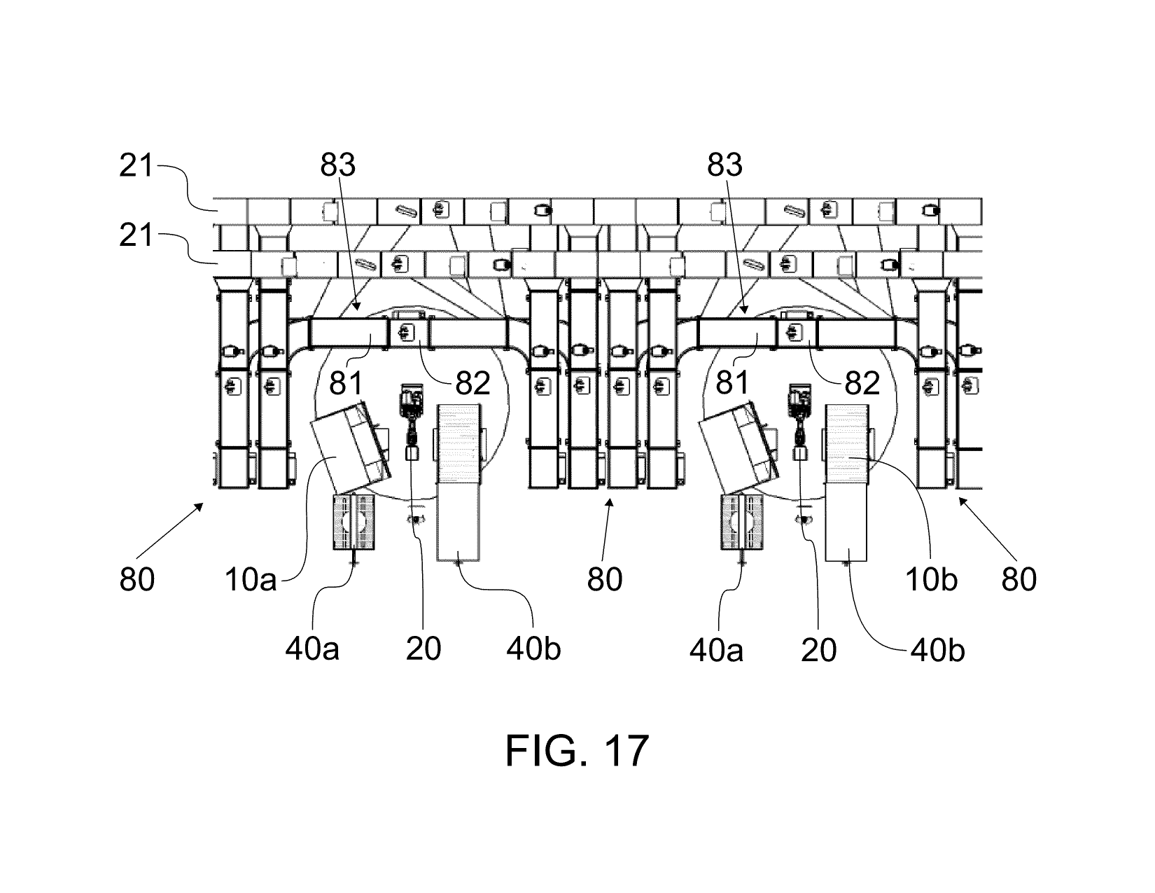

According to one embodiment, the loading cell 60 of the loading system is equipped with a buffer store 83, in order to even out variations in the flow of pieces arriving on the feed conveyor 20 from the main conveyor 21 (FIGS. 16 and 17). This embodiment responds to momentary loading peaks appearing in the baggage-handling process, which are due, for example, to the fact that the feed speed of the airport transfer conveyor is more than the pace time of the packing event. Equipping the loading cell 60 with an internal buffer store 83 can resolve these smallish and momentary natural dimensioning bottlenecks appearing in the totality.

However, there can also be more significant variations in the piece-goods flows of airport baggage handling systems, which are due to piece goods being consolidated at a specific time from several short-haul flights into a single long-haul flight, or, conversely, piece goods being distributed from a single long-haul flight to several short-haul flights. Such congestion peaks directly affect the packing percentage of the air-transport units, in which case even a loading cell 60 equipped with an internal buffer 83 may momentarily form a bottleneck in the packing process.

Thus, particularly a separate buffer store 80 intended to even the more important piece-goods flows has no need for its own packing function, but only devices and software, with the aid of which a loading-cell's 60 piece-goods batch, which is intended to be packed into the same air-transport unit 10, can be received and also dispatched rapidly. A separate buffer store 80 can thus serve one or several loading cells 60. Indeed it is advantageous to have the piece-goods batches transfer rapidly to the feed conveyor 20. The faster an individual packing movement or event can be performed, the shorter the arrival interval of baggage intended for the same air-transport unit 10 at the robot will need to be.

In the examples of FIGS. 16 and 17, the pieces 30 arriving from the main conveyor 21 are guided through a separate buffer store 80 to the feed conveyor 20, which according to one embodiment is a robot like that described above, which is arranged to load two air-transport units 10a, 10b manipulated by two parallel handling devices 40a, 40b. In addition, the loading cells 60 are equipped with an internal buffer store 83 between the separate buffer store 80 and the feed conveyor 83.

As stated, the task of the separate buffer store 80 is to even the peaks of arriving piece goods. The buffer store 80 is controlled by a control system (not shown) integrated in the airport material-flow control system, which receives information on the state of the buffer store 80 by means of presence sensors fitted to it, which are, as such, known. Thanks to the buffer store 80, alterations need not be made to the speed or operation of the main conveyor 21, if the loading cell 60 causes a bottleneck in the packing process due to a piece-goods logjam. As can further be seen from FIGS. 16-18, the buffer store 80 receives piece goods from the main conveyor 21 separate by a separator 22.

In the buffer store 80, the pieces 30 are stored on conveyors 81, which are arranged on different levels, so that the height of the loading cell 60 can be exploited. If there is little surface area available, the buffer store 80 can be expanded to run above or below the loading cell 60 or both above and below it. There is a lift 82 between the conveyors 81, by means of which the pieces 30 can be transferred from one conveyor 81 to another.

In the case of several main conveyors 21, the pieces 30 can be fed to the loading cell by several separators 22, when the pieces will come to several conveyors 81, from which they are fed by the lift 82 to the feed conveyor 20. If the packing need is small, a simple conveyor, which transfers the piece goods 30 directly from the separator 22 to the feed conveyor 20 without a lift 82 and conveyors on different levels, can be used as the buffer store 80.

The internal buffer store 83 and the separate buffer store 80 can be implemented using a similar construction.

TABLE 1
LIST OF REFERENCE NUMERALS.

| No. | Component |
|---|---|
| 10 | air-transport unit |
| 11 | loading opening |
| 20 | feed conveyor |
| 21 | main conveyor |
| 22 | Separator |
| 30 | Piece |
| 40 | handling device |
| 41 | transfer device |
| 50 | Tug |
| 51 | Cart |
| 60 | loading cell |
| 80 | separate buffer store |
| 81 | Conveyor |
| 82 | lift |
| 83 | internal buffer store |
| 100 | start of new loading batch |
| 102 | bring new container to |
| | loading location |
| 103 | check for pieces to be loaded |
| | in the loading batch |
| 104 | check container positioning |
| 106 | select first row in container |
| 108 | select first location in row |
| 110 | check if location is free |
| 112 | load location |
| 114 | select next location |
| 116 | check whether last location |
| | in row |
| 118 | check whether last row in |
| | container |
| 120 | tilt container |
| 122 | select next row in container |
| 124 | close loading opening in |
| | filled container |
| 126 | check whether last container |
| | in loading batch |
| 128 | dispatch loaded container |
| | from loading cell |
| 130 | terminate loading batch |

1. The method for loading piece goods automatically into an air-transport unit, in which method:
transporting the piece goods and the air-transport unit, on at least one side of which there is an openable loading opening, to the packing location, wherein on at least one side of the air-transport unit there is an openable loading opening, and
packing the piece goods automatically through the loading opening into the air-transport unit,
tilting the air-transport unit in connection with packing in such a way that the side with the loading opening is elevated relative to the side opposite to the loading opening, wherein the air-transport unit is loaded in at least two different attitudes.

2. The method according to claim 1, in which the loading opening of the air-transport unit is closed once loading has ended.

3. The method according to claim 1, in which the air-transport unit is an air container or a baggage cart.

4. The method according to claim 1, in which the air-transport unit is tilted around its horizontal axis.

5. The method according to claim 1, in which the air-transport unit is manipulated in several degrees of freedom.

6. The method according to claim 1, in which the air-transport unit is tilted in such a way that the loading opening rotates relative to the tilting axis or tilting axes.

7. The method according to claim 1, in which the air-transport unit is tilted around its horizontal axis, in such a way that the essentially vertical loading opening is tilted towards a horizontal position.

8. The method according to claim 1, in which the air-transport unit is tilted through 90 degrees around its horizontal axis, in such a way that the vertical loading opening is tilted towards a horizontal position, wherein the transport unit is first of all loaded from the side and then, after tilting, from above.

9. The method according to claim 1, in which the air-transport unit is manipulated backwards and forwards relative to at least one degree of freedom, in order to compact the pieces inside the air-transport unit.

10. System for automatically loading air-transport units with piece goods, which system comprises:
means for bringing the piece goods to the loading location,
means for bringing an air-transport unit to the loading location,
means for packing the piece goods into the air-transport unit through its loading opening, and
means for manipulating the air-transport unit, which means is configured to manipulate the air-transport unit to be loaded in at least two different attitudes.

11. The system according to claim 10, wherein the means for manipulating the air-transport unit is arranged to tilt the air-transport unit relative to at least one axis in such a way that the side with the loading opening is raised relative to the side opposite to the loading opening.

12. The system according to claim 10, wherein the means for manipulating the air-transport unit is arranged to manipulate the air-transport unit backwards and forwards relative to at least one degree of freedom in order to compact the pieces inside the air-transport unit.

13. The system according to claim 10, wherein the means for manipulating the air-transport unit is arranged to manipulate the air-transport unit in several degrees of freedom in order to position the air-transport unit relative to the means for packing piece goods.

14. The system according to claim 13, wherein the means for manipulating the air-transport unit is an industrial robot which is equipped with a grab suitable for gripping the air-transport unit.

15. The system according to claim 10 which comprises a buffer store inside the packing cell for evening variations in the flow of piece goods arriving at the packing location.

16. The system according to claim 10 which comprises a separate buffer store, for evening variations in the flow of piece goods arriving at the packing location.

17. The system according to claim 15 which comprises a separate buffer store, for evening variations in the flow of piece goods arriving at the packing location.
